(19) United States
(12) Patent Application Publication
(10) Pub. No.: US 2005/0055226 A1
(43) Pub. Date: Mar. 10, 2005

(54) Method and apparatus for recruitment process management

(76) Inventors: Mark Dane, Sharon, MA (US); Bela A. Labovitch, Newton, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 10/655,572

(22) Filed: Sep. 4, 2003

(51) Int. Cl. G06F 17/60

(52) U.S. Cl. 705/1

(57) ABSTRACT

A system for recruitment process management is provided that can be used as a tool for performing a consistent process of developing a request for talent (RFT). Such a system may be capable of storing previous RFT information to be used for generating future RFTs. A process for creating a dynamic job description is provided that allows a person referred to herein as a requirements specialist to work with a client (e.g., a human resource manager or other person) to create a job description in an interactive manner. The system may be adapted to display to both the requirements specialist and the client, information relating to the composition of an RFT.

### BACKGROUND OF THE INVENTION

1. Field of Invention The field of the invention relates generally to knowledge management, and more particularly, to recruiting and job placement.

2. Discussion of Related Art

Traditionally, recruiters (or headhunters, as they are more commonly referred) and human resources (HR) personnel (hereinafter “recruiters”) manage company recruiting of employees. This process generally involves determining, by the recruiter, what hiring needs are present, developing job descriptions and/or ads that can be placed in newspapers and/or online, and revising such descriptions and/or ads. Recruiters often have different roles, such as performing interviews, contacting candidates, preparing correspondence and other tasks of which they need to be proficient.

The time to recruit and hire a candidate is a long process. To begin the recruiting process, recruiters often meet with clients (e.g., managers) to determine their hiring needs and to define job descriptions and ads for placement. Often, these descriptions of hiring needs to not translate well into ads or descriptions because of miscommunication between the recruiter and client, the unfamiliarity of the recruiter in the client's business and roles, inexperience of the recruiter in the hiring process. This miscommunication results in incorrect job definitions, and leads to receiving candidates that are not matched well to the job to be performed, and this delays the overall recruiting and hiring process. What it needed, therefore, is a more efficient manner for managing the recruiting process.

### SUMMARY OF THE INVENTION

The recruitment process generally begins with a definition of the customer's requirements. One aspect of the invention relates to the development of what is referred to hereinafter as a Request For Talent (RFT). An RFT is a job specification that lists requirements that a candidate applying for the job described should meet. An RFT may include, for example, educational requirements, previous work experience, and other requirements. A thorough and precise job description is key for delivering quality candidates in a timely manner. According to one aspect of the invention, a system and method is provided for developing RFTs in a consistent manner.

In one aspect, a system is provided that can be used as a tool for recruitment process management. As discussed above, the system is capable of formalizing the job description development process so that job descriptions are more easily and consistently developed. In one embodiment, the system combines knowledge, process, technology, and talent to create RFTs. More particularly, the system may use stored knowledge to assist a user in creating an RFT, a well-defined process that assists in creating RFTs consistently, technology to systematize the RFT creation process and talent to reduce human error due to inexperience and unfamiliarity of the client's business.

In one aspect of the invention, a user may add items to a knowledge base which then can be used to develop further RFTs. Also, in one aspect, the process by which RFTs are developed is systematized such that a consistent process is followed each time an RFT is developed. Because the process for developing an RFT is consistent, and content of the RFT may be derived using information stored in an existing knowledge base, drawbacks due to inexperience in developing job descriptions and unfamiliarity with a clients' business is minimized. That is, knowledge may be developed from previous job descriptions, resumes, and other information, and as a result, unique job descriptions may be created more quickly and consistently.

In one embodiment, knowledge is accumulated from previous job descriptions and other sources for future use. This knowledge may be associated with a particular job title which can be stored and used for future reference (e.g., for searching, creation of new RFTs, comparison with collected information for locating candidates). This knowledge may be collected, for example, from resumes and previous job descriptions. According to one aspect, it is realized that there is a finite number of permutations of information that can be used to describe a job. For example, keywords may be used that describe a job function associated with a particular RFT. Also, keywords may be used to describe educational requirements, qualifications, and other information associated with an RFT. These keywords and their associations to job titles, educational requirements, etc. may be stored in a database for use in generating an RFT.

One aspect of the present invention relates to providing a service for developing job descriptions. As discussed above, the recruitment process is a long process that involves in-house hiring personnel. Some of this personnel cost may be alleviated by providing a recruitment management service. As part of one example service, a recruitment management coordinator can work directly with the client (e.g., to develop job descriptions) with minimal to no involvement by in-house HR personnel. Such a service may be provided using one or more of the systems and methods for recruitment process management described herein. In this manner, the coordinator may be assisted by the system to perform the service with minimal education of client's business. Clients also benefit as they can use the outside service without having to hire an expert in-house.

In another aspect of the invention, a person referred to hereinafter as a “requirements specialist” works with the client interactively to develop a blueprint of the job that the client is attempting to fill. This requirement specialist is similar to a police sketch artist or architect that communicates with a client to fulfill their needs (e.g., develop a sketch by a witness or develop a design for a house). The requirements specialist follows a process set out by the system to create the job description and receives real-time feedback from the client during the job description development process so that the description is more accurate and more quickly generated.

In one embodiment, the system may be implemented as a distributed system whose elements cooperate over a communication network (i.e., the Internet). In another embodiment, the distributed system allows a client and a specialist to interactively develop an RFT. Such a distributed system may include a client station and a specialist station which allow the client and specialist to interact. More particularly, the client station and specialist station may simultaneously display, to the client and specialist, respectively, information relating to the job description process and information selected/used in developing the job description. The distributed system may have an interface that allows a user (e.g., a client and/or specialist) to select stored qualifications and skills relating to a task for a job description. In one embodiment, the system may allow the user to prioritize certain tasks relative to other tasks

More particularly, the system, according to one embodiment, may allow the user to prioritize tasks (e.g., what qualifications are needed by a candidate and in what priority are these qualifications to one another). Many problems relating to receiving applicants that are not well-matched is caused by the hiring manager not knowing what experience is most important in performing particular tasks (a candidate's qualifications). According to one aspect of the invention, a user (e.g., a specialist and/or client) is capable of specifying the priority of tasks so that candidates having experience performing the higher priority tasks may be identified. In one embodiment of the invention, tasks may be categorized as required tasks, i.e., tasks for which experience is required, or desired tasks, i.e., tasks for which experience is desired or if present, makes one candidate preferable over another without the desired experience. In one embodiment, the amount of experience may be specified and may be used as criteria for locating an acceptable candidate. Further, a role (e.g., leader, contributor, etc.) may be specified by the user to more accurately define the role of the candidate in performing the particular task, and the role may be used as criteria for locating an acceptable candidate.

According to one aspect of the invention, a method is provided for managing recruiting information. The method comprises acts of developing a job description, the first job description comprising a first set of components, storing the first set of components in a database, and creating a second job description having a second set of components, at least one of which is selected from the first set of components stored in the database. According to one embodiment, the method further comprises an act of determining, by a requirements specialist, the first set of components. According to another embodiment, the act of determining comprises an act of receiving, from the requirements specialist, a selection of at least one of the first set of components and simultaneously displaying the selection to a client.

According to another embodiment, the act of storing further comprises an act of storing the first set of components in a relational database. According to another embodiment, the method further comprises an act of displaying the selection to the requirements specialist in a display of a computer associated with the requirements specialist. According to another embodiment, the act of displaying the selection includes an act of displaying the selection to the client in a display of a computer associated with the client. According to another embodiment, the act of displaying the selection includes an act of displaying the selection to the client in a display of a computer associated with the client.

According to another embodiment, the act of determining comprises an act of determining, by the requirements specialist, the first set of components on the basis of an interactive communication with a client. According to another embodiment, the acts of developing, storing, and creating are facilitated by the use of at least one computer system.

According to another embodiment, the first set of components comprises at least one component that identifies an educational requirement associated with a candidate. According to another embodiment, the first set of components comprises at least a task to be performed by a candidate.

According to another aspect of the invention, a method is provided for interactively developing a job description. The method comprises acts of receiving, by a requirements specialist from a client, hiring needs, and determining, by the requirements specialist based on the received hiring needs, at least one portion of a job description.

According to one embodiment of the present invention, the method further comprises an act of displaying, in a display of a computer system associated with the client, the at least one portion of the job description determined by the requirements specialist. According to another embodiment, the method further comprises an act of displaying, in a display of a computer system associated with the requirements specialist, the at least one portion of the job description determined by the requirements specialist. According to another embodiment, the at least one portion is stored in a database, and wherein the method further comprises an act of selecting the at least one portion from the database for use in the job description.

According to another embodiment, the at least on portion includes at least one of a group of information comprising a task, a job function, educational information, and a qualification, and wherein the method further comprises selecting the at least one of the group from database for use in the job description.

Further features and advantages of the present invention as well as the structure and operation of various embodiments of the present invention are described in detail below with reference to the accompanying drawings. In the drawings, like reference numerals indicate like or functionally similar elements. Additionally, the left-most one or two digits of a reference numeral identifies the drawing in which the reference numeral first appears.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a general purpose computer and network system in which various aspects of the present invention may be practiced;

FIG. 2 is an architecture diagram of a recruitment process management system according to one embodiment of the present invention;

FIG. 3 is a flow chart of a process for developing an RFT according to one embodiment of the present invention;

FIG. 4 is a block diagram of a data model used by a recruitment process management system;

FIG. 5 is an example user interface according to one embodiment of the present invention that may be presented to a user by a recruitment process management system to login a user;

FIG. 6 is another example of a user interface according to one embodiment of the present invention that may be presented to a user by a recruitment process management system to allow the user to define an RFT;

FIG. 7 is another example of a user interface according to one embodiment of the present invention that may be presented to a user by a recruitment process management system to allow the user to define an RFT;

FIG. 8 is another example of a user interface according to one embodiment of the present invention that may be presented to a user by a recruitment process management system to allow the user to prioritize tasks;

FIG. 9 is another example of a user interface according to one embodiment of the present invention that may be presented to a user by a recruitment process management system to allow the user to prioritize qualifications;

FIG. 10 is another example of a user interface according to one embodiment of the present invention that may be presented to a user by a recruitment process management system to allow the user to modify a task;

FIG. 11 is another example of a user interface according to one embodiment of the present invention that may be presented to a user by a recruitment process management system to allow the user to modify a qualification;

FIG. 12 is another example of a user interface according to one embodiment of the present invention that may be presented to a user by a recruitment process management system to allow the user to add a new task;

FIG. 13 is another example of a user interface according to one embodiment of the present invention that may be presented to a user by a recruitment process management system to allow the user to add an educational requirement;

FIG. 14 is another example of a user interface according to one embodiment of the present invention that may be presented to a user by a recruitment process management system that displays to the user a real-text description associated with an RFT;

FIG. 15 is another example of a user interface according to one embodiment of the present invention that may be presented to a user by a recruitment process management system to allow the user to enter/update client information;

FIG. 16 is another example of a user interface according to one embodiment of the present invention that may be presented to a user by a recruitment process management system to allow the user to enter/update tasks associated with a particular job title and company;

FIG. 17 is another example of a user interface according to one embodiment of the present invention that may be presented to a user by a recruitment process management system to allow the user to enter/update qualifications associated with a particular job title and company; and

FIG. 18 is another example of a user interface according to one embodiment of the present invention that may be presented to a user by a recruitment process management system to allow the user to manage RFTs.

### DETAILED DESCRIPTION

As discussed above, one aspect of the present invention relates to system for recruitment process management that can be used as a tool for performing a consistent process of developing an RFT. Such a system may be capable of storing previous RFT information to be used for generating future RFTs.

Another aspect of the invention relates to a process for preparing an RFT. More specifically, a process for creating a dynamic job description is provided that allows a person referred to herein as a “requirements specialist” to work with a client (e.g., a human resource manager or other person) to create the job description in an interactive manner. The requirements specialist is similar to, for example, a police sketch artist or an architect that communicates with client to determine their needs. More particularly, the requirements specialist jointly works with the client to develop a blueprint of the job that the client is attempting to fill. The requirements specialist follows an interactive process involving a dialog between the specialist and client to generate the RFT.

The system may be adapted to display, to both the requirements specialist and the client, information relating to the composition of an RFT. Such information may include, for example, keywords that describe a job function associated with a particular RFT, educational requirements, qualifications, and other information associated with an RFT. In one embodiment, the system is capable of storing job descriptions previously developed, and the system may enable a user to select portions of these descriptions for use in developing a new RFT.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to manage a recruiting process according to various embodiments of the invention. Further, the recruitment management system may be located on a single computer or may be distributed among a plurality of computers attached by a communications network.

A general-purpose computer system according to one embodiment of the invention is configured to perform any of the described recruitment management functions including but not limited to developing an RFT, providing an outsourced service for managing the recruiting process, etc. It should be appreciated that the system may perform other functions, including storing and/or managing information used in generating job descriptions, and the invention is not limited to having any particular function or set of functions.

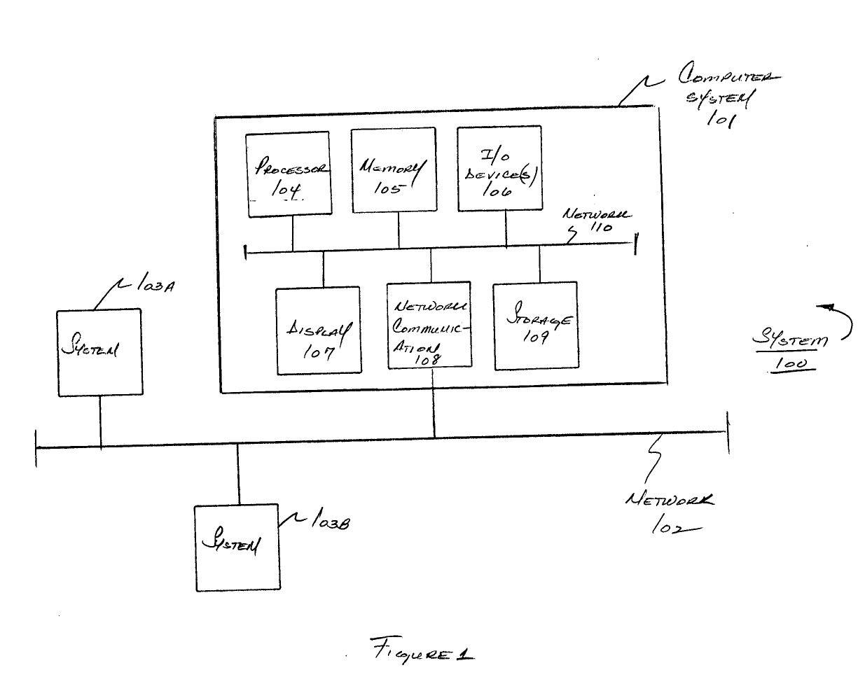

FIG. 1 shows a block diagram of a general purpose computer and network system in which various aspects of the present invention may be practiced. For example, various aspects of the invention may be implemented as specialized software executing in one or more computer systems including general-purpose computer system 101 shown in FIG. 1. Computer system 101 may include a processor 104 connected to one or more memory devices 105, such as a disk drive, memory, or other device for storing data. Memory 105 is typically used for storing programs and data during operation of the computer system 101. Components of computer system 101 may be coupled by an interconnection mechanism such as network 110, which may include one or more busses (e.g., between components that are integrated within a same machine) and/or a network (e.g., between components that reside on separate discrete machines). The interconnection mechanism enables communications (e.g., data, instructions) to be exchanged between system components of system 101.

Computer system 101 also includes one or more input/output (I/O) devices 106, for example, a keyboard, mouse, trackball, microphone, touch screen, a printing device, display screen, speaker, etc. In addition, computer system 101 may contain one or more interfaces (e.g., network communication device 108) that connect computer system 101 to a communication network (in addition or as an alternative to the network 110.

The storage system 109, typically includes a computer readable and writeable nonvolatile recording medium in which signals are stored that define a program to be executed by the processor or information stored on or in the medium to be processed by the program. The medium may, for example, be a disk or flash memory. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). The memory may be located in storage system 109, as shown, or in memory system 105. The processor 104 generally manipulates the data within the integrated circuit memory 104, and then copies the data to the medium associated with storage 109 after processing is completed. A variety of mechanisms are known for managing data movement between the medium and integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 101 is shown by way of example as one type of computer system upon which various aspects of the invention may be practiced, it should be appreciated that aspects of the invention are not limited to being implemented on the computer system as shown in FIG. 1. Various aspects of the invention may be practiced on one or more computers having a different architectures or components that that shown in FIG. 1.

Computer system 101 may be a general-purpose computer system that is programmable using a high-level computer programming language. Computer system 101 may be also implemented using specially programmed, special purpose hardware. In computer system 101, processor 104 is typically a commercially available processor such as the well-known Pentium class processor available from the Intel Corporation. Many other processors are available. Such a processor usually executes an operating system which may be, for example, the Windows-based operating systems (e.g., Windows NT, Windows 2000 (Windows ME), Windows XP operating systems) available from the Microsoft Corporation, MAC OS System X operating system available from Apple Computer, the Solaris operating system available from Sun Microsystems, or UNIX operating systems available from various sources. Many other operating systems may be used, and the invention is not limited to any particular operating system.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems (e.g., servers) configured to provide a service to one or more client computers, or to perform an overall task as part of a distributed system. For example, various aspects of the invention may be performed on a client-server or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Various aspects of this system can be implemented by one or more systems within system 100. For instance, the system may be a distributed system (e.g., client server, multi-tier system). In one example, the system includes software processes executing on a system associated with a specialist and a system associated with a client. These systems may simultaneously display RFT information and its development to both the client and specialist. More particularly, the client can view a job description while it is being generated by the specialist. In another example, the system can accept information both from the specialist and the client, and therefore both the client and specialist can provide input to an RFT being generated.

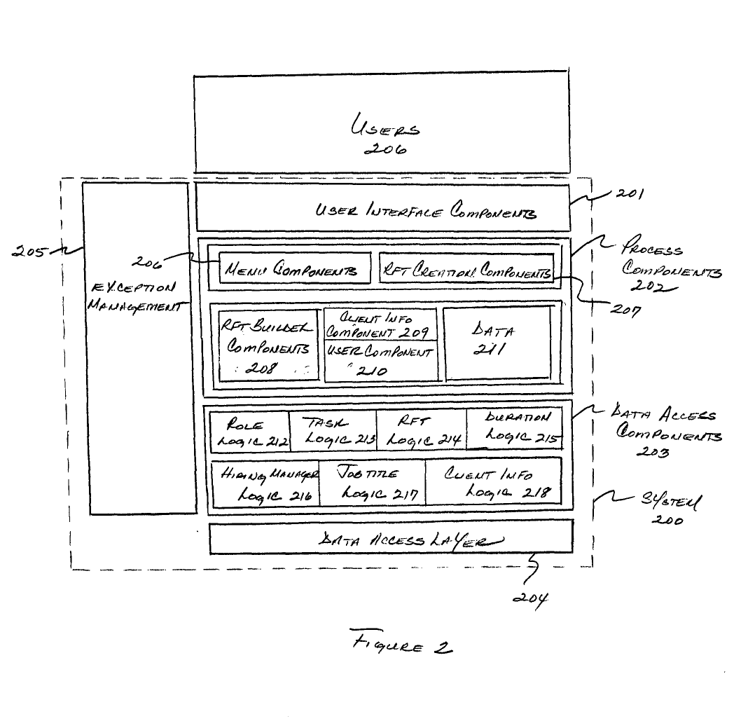

FIG. 2 shows an architecture diagram of a recruitment process management system according to one embodiment of the invention. System 200 includes one or more user interface components 201, process components 202, and data access components 203. System 200 may also include an exception management component 205 that performs exception management functions within the system as is well-known in the art. System 200 may also include a number of access layer components 204 that facilitate access to data stored by system 200.

User interface components 201 include a number of components that accept or display information to one or more users 206. These user interface components may be, for example, programmed using the NET framework available from the Microsoft Corporation. In one embodiment, Winforms or ASP.NET pages (Active Server Pages—a server-side scripting environment that can be used to create and run dynamic, interactive web-based server applications) can utilize user interface components to create a user interface. Although various aspects of the invention may be developed using the NET framework (Winforms or ASP.NET pages), it should be appreciated that any programming language, framework, or environment may be used, and the invention is not limited to any particular implementation. For example, various aspects of the invention may be implemented in the J2EE framework available from Sun Microsystems, Inc.

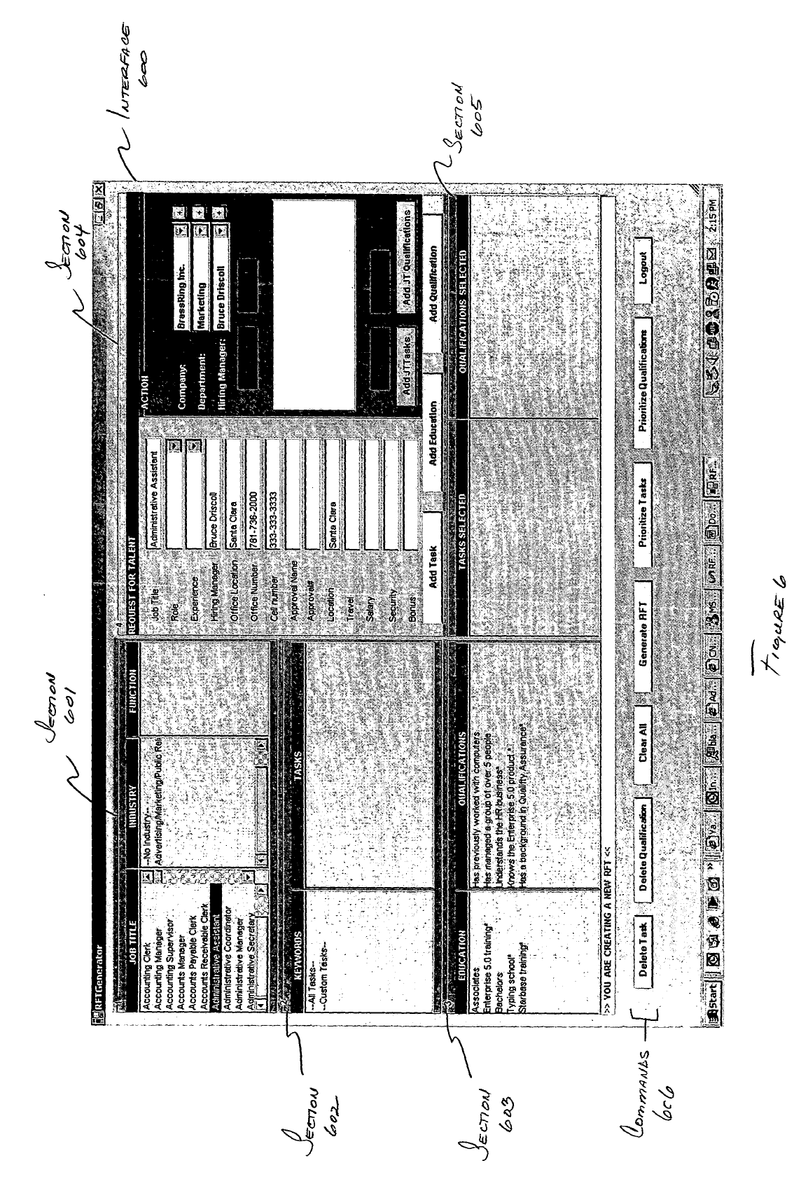

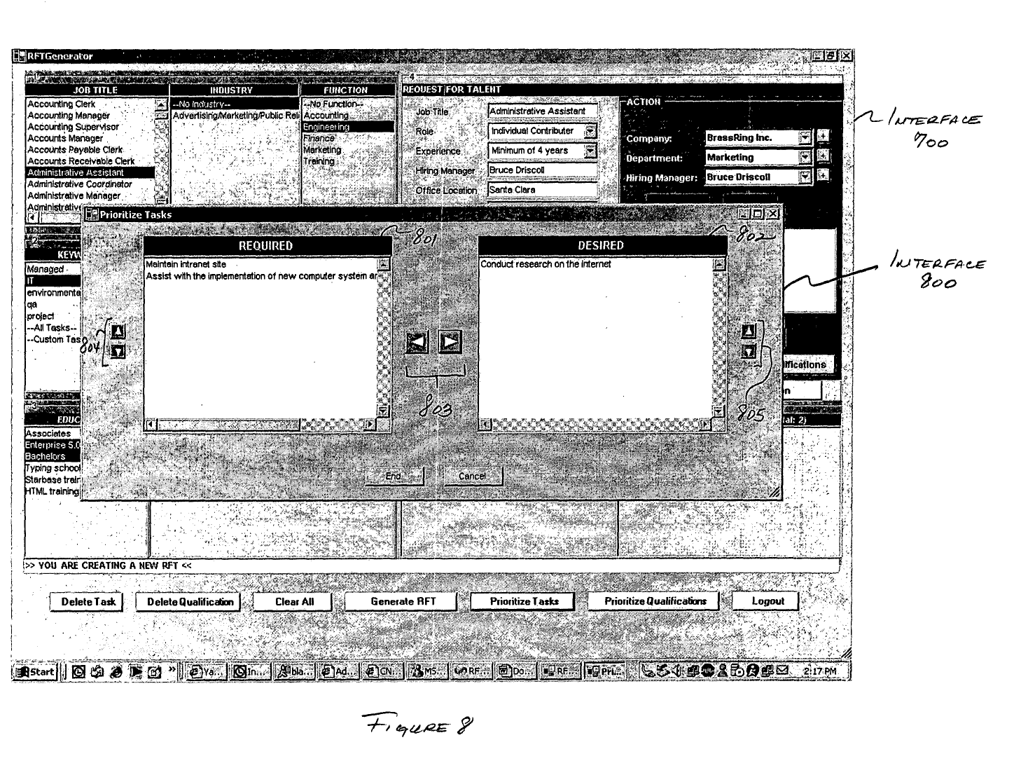

User interface components 201 may control how information is displayed and received through the user interfaces to users 206. Various user interfaces and their features are discussed in more detail below with respect to FIGS. 6-8. In association with this user interface are a number of process components 202 which receive user input (e.g., an activation of a menu option, creation of an RFT, selection of a displayed data value, etc.) can provide such information to a number of other components.

For example, the menu components 206 may include a class that services a Windows form that produces menu options. This class may also store the context of the current client, department and hiring manager a user is working with to generate the RFT. For example, the class may store a current client identifier that uniquely identifies a particular client. Further, there may be stored a department identifier that uniquely identifies a department associated with the client identified by the client ID. Further, the class may store a hiring manager identifier that identifies a particular hiring manager. Such a class may also one or more functions that initiates a client, department, and hiring manager identifier, returns a list of clients, returns departments for a given client, or saves any of these identifiers to a database.

Components 202 may also include a number of RFT creation components 207 which handle the RFT creation process. Components 207 may include at least one object class that manages information associated with an RFT to be generated. In particular, this class may instantiate an RFT, obtain information related to the RFT creation, and saving the data related to the RFT to a database. In particular, components 207 may include a function that returns a list of stored job titles, a list of stored valid roles, and other information that may be used to create an RFT. This class may also include a function which sets a job title that is selected by a user for the RFT, and may obtain and set information associated with the job title selected by the user. For instance, this class may return a list of industries that are associated with tasks of this job title, return a list ofjob functions associated with tasks for this job title, filtered by industry, returns a list of keywords associated with tasks for this job title, filtered by job function, etc. This class may also return a list of job qualifications for this job title, return a list of educational requirements for this job title, and returning a list of qualifications associated with a given task of this job title.

Components 202 also includes RFT builder components 208 which may include one or more classes that interact with data access components 203 and return information to the user interface components 201 as an RFT is built. The class may include, for example, functions that obtain and cached information from the database including tasks, interview questions, job titles, education, qualifications, and task IDS. Components 208 may also include functions that, for example, return a list of all valid job titles, lists of all potential educational requirements, and/or potential qualifications for an RFT. Components 208 may also include functions that obtain the information from the database and populate a local data set associated with this job title with information from the database.

Components 202 may also include a client information component 209 which returns client information related to a particular client. In one embodiment, component 209 includes a class that caches data related to one or more clients and performs a number of functions relating to client information. In one embodiment, component 209 includes a data set that caches a list of all available clients. This data set may be stored in a data structure such as a table. The class may also be responsible for obtaining, from the database, a list of valid clients, searching and selecting information related to the clients, and providing this information to user interface components 201. For example, component 209 may perform functions including returning a list of departments for a given client, returning a list of hiring managers for a given department, returning a data table containing a list of all clients, and other functions.

Components 202 may include a user component 210 that stores data and contains methods related to an application user (e.g., users 206). For example, component 210 includes a class that stores a user name associated with a particular user, constructs a new user associated with system 200, and/or performs authentication functions associated with the user name.

Components 202 also includes a data component 211 which is responsible for storing and tracking information associated with a current RFT being created.

System 200 also includes a number of data access components 203 that are responsible for accessing data through data access layer 204. Components 203 may include a role logic 212 that obtains role-related information from the database. Component 212 may include a class that performs a number of functions including obtaining a list of all roles in the database. Components 203 may also include a test logic component 213 that is capable of accessing task-related information from the database. Component 213 may include a class object that performs a number of functions including creating a data set containing information relating to all the tasks associated with a given job title. This class may also be responsible for storing task information. For instance, this information may be stored in one or more different data tables and may be accessed by other objects.

Components 203 may include RFT logic component 214 which performs data access functions related to an RFT. Component 214 may include one or more objects that perform a number of functions, including managing information relating to a particular request for talent. In particular, component 214 may include functions that save and retrieve data related to a particular request for talent.

Components 203 may include a duration logic component 215 that accesses duration information in the database and returns relevant data. In particular, component 215 may include one or more object classes that perform a variety of functions, including returning a list of valid durations from the database. This information may be stored, for example, in a table structure in the database and may be retrieved into a table for use by other components.

Components 203 may include hiring manager logic component 216 that sets and retrieves information relating to the hiring manager. For instance, component 216 may include one or more object classes that perform a number of functions including setting client, department, and/or hiring manager identifiers in the database. Component 216 may also be capable of retrieving information relating to a particular hiring manager.

Components 203 may include a job title logic component 217 which manages job title relation information in the database. Component 217 may include one or more objects that perform a number of functions, including obtaining a list of all titles in a job title table, returning the educational requirements for a job title, and returning a list of all qualifications for a specified job title. In one embodiment, the object returns educational requirements and qualifications at the title of and not a task level. That is, the object returns educational requirements and qualifications based on the title of the job without reference to any particular task.

Components 203 may also include client information logic component 218 which accesses the database for client-related information. Component 218 may include one or more objects that perform a number of functions including returning a list of all clients stored in a database, and returning client information to be included in an RFT.

System 200 may also include a data access layer 204 which includes functions that access the database. For example, this layer may include functions that access a relational database using, for example, SQL commands. System 200 may have an associated database (not shown) that stores and retrieves RFT data, resumes, and other information. This database may be a relational database (e.g., Oracle database) or any other database type.

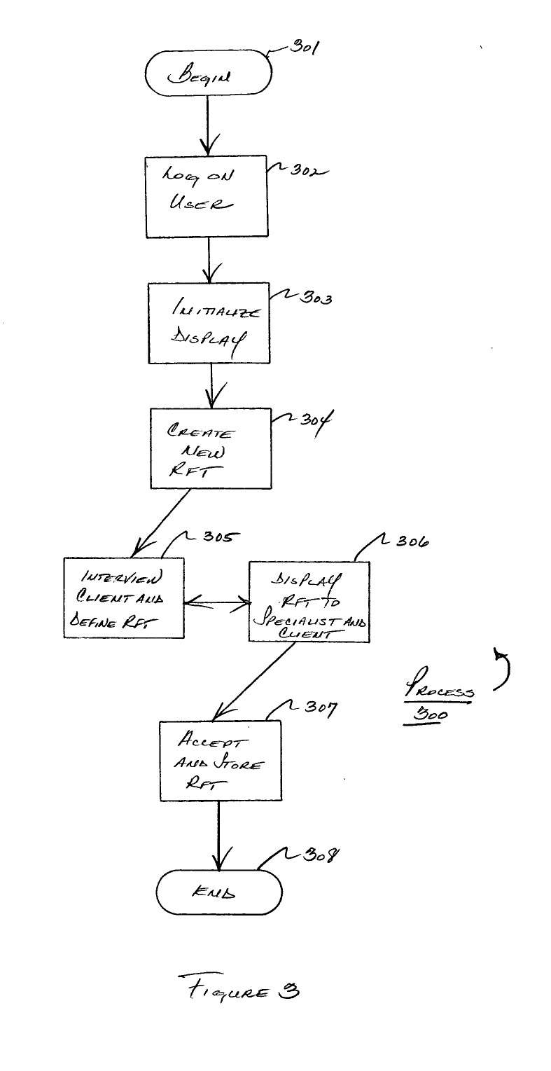

FIG. 3 shows an example process 300 for developing an RFT according to one embodiment of the present invention. For instance, process 300 may be performed by system 200 as discussed above with reference to FIG. 2. At block 301, process 300 begins.

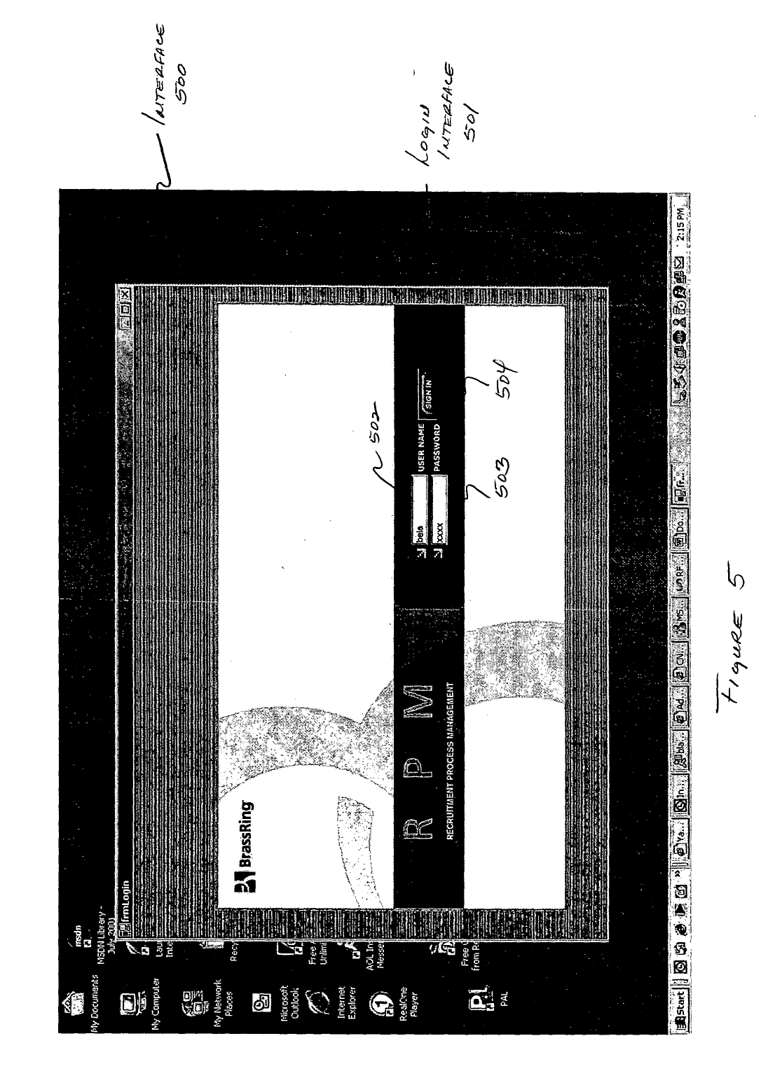

At block 302, a user (e.g., user 206) is logged onto a recruitment process management system (e.g., system 200). In one embodiment, a login interface (e.g., interface 500 discussed in more detail below with respect to FIG. 5) may be presented to the user wherein credential information (e.g., user name and password) may be entered, and the user may be allowed access to the system.

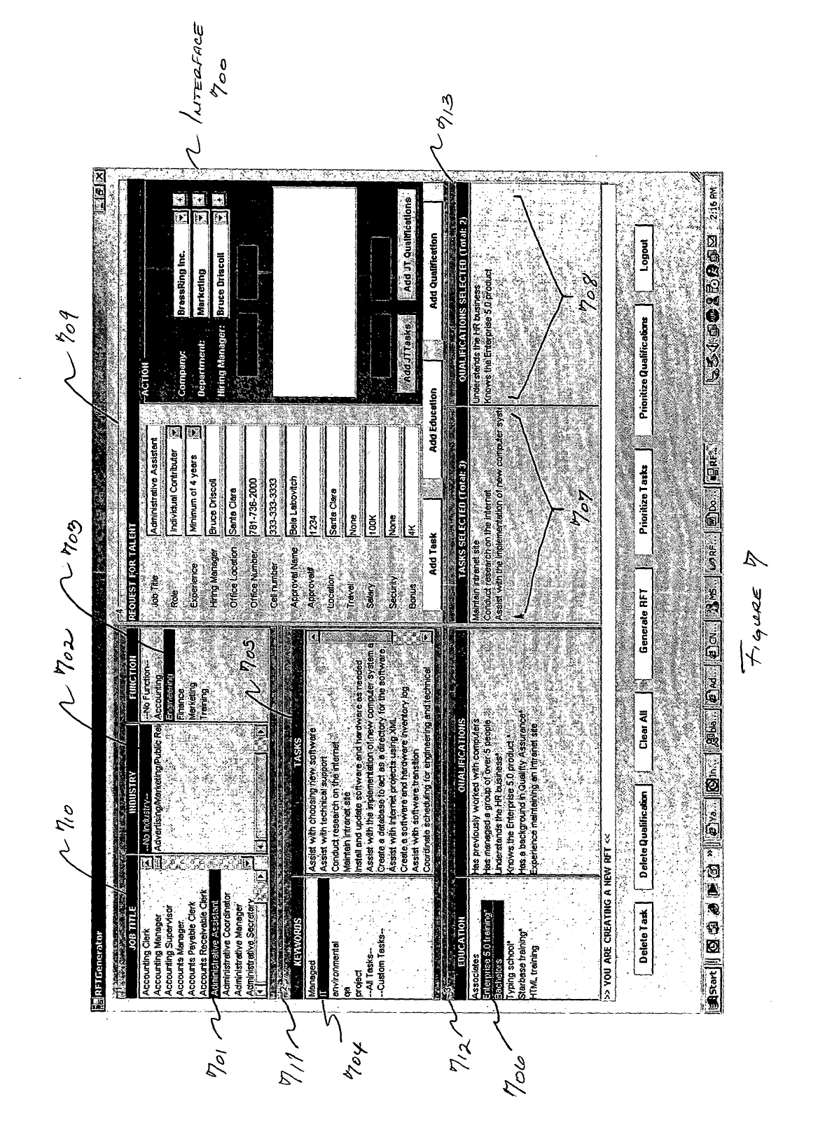

At block 303, a display may be initialized and displayed to the user. This display may be a main display associated with the recruitment management system (e.g., interface 700 discussed below with reference to FIG. 7), and may provide a number of menu options to the user. For example, this display may allow a user to save and retrieve RFT information, print, send or perform other functions associated with the creation of an RFT. For instance, menu components 206 as discussed above with reference to FIG. 2 may be capable of performing a number of functions from a menu created by such components. As discussed in more detail below with respect to several example user interfaces, the display may include a number of different windows that display information related to the current RFT being created and may allow a user to select information stored within the database for use in generating a new RFT.

At block 304, a new RFT is created. For example, this new RFT may be a “blank” or empty RFT generated in response to a user selecting a menu option to create a new RFT. Alternatively, the user may be presented an option to load and continue to work on an RFT that is not yet complete.

At block 305, the RFT is defined by a user, and in another embodiment of the invention, a requirements specialist is responsible for interviewing the client and defining the RFT. At block 306, the RFT being defined is displayed to the client, and in one embodiment, the RFT being defined is displayed to both the specialist and the client. For instance, the RFT may be displayed in separate displays of host systems associated with the requirements specialist and the client, respectively. As discussed above, job-related information may be stored within the database and retrieved and selected by a user for the current RFT. This information may include, for example, job title, industry, function, keywords, tasks, education, qualifications, etc. In one embodiment, an interview of the client and creation of the RFT may be an iterative process through which the RFT is created.

At block 307, the RFT information generated may be accepted and stored in the database. This information may be, for example, printed, finalized, or saved temporarily for later editing. At block 308, process 300 ends. Although a recruitment management system may be used primarily for creating job descriptions, it should be appreciated that such a system may perform other functions. For example, the system may be capable of accessing and modifying information to the database (e.g., to load information to, or revise data in fields of the database), and performing general database functions. More particularly, the system may be used to load and revise field data, such as adding new clients, hiring managers, revising stored job descriptions, tasks and/or qualifications, etc.

As discussed above, information may be stored in a database. In one embodiment of the invention, information can be organized in a hierarchical manner in the database. For example, the parameter “Job Title” may be a primary index of the database, through which all other data types are associated. A user interface may allow the specialist to select a particular job title, which is then presented to the client. The Job Title may have an associated “Industry,” that allows the specialist to further define the position. It is realized that a particularjob title (e.g., administrative assistant) may have a different set of tasks, descriptions, education for one industry versus another (e.g., a legal administrative assistant compared to an engineering administrative assistant). Therefore, it is realized that the background and requirements for a candidate may also be different for these industries. As a result, it may be beneficial to store different education and qualifications based on a particular job in an industry. Therefore, the system may store multiple sets of information each of which corresponds to an industry job/title combination.

Further, it is realized that there may be distinct job functions associates with a particular job title. For example, for the job title of “administrative assistant” there may be a number of primary functions that an administrative assistant can perform which affects the education and qualifications required for the job. More particularly, an administrative assistant can have a public relations function which would require different skills and experience than an administrative assistant in engineering. Such different job functions may also have different associated sets of education and qualifications. Therefore, the system may store and present different sets depending on the particular job function selected.

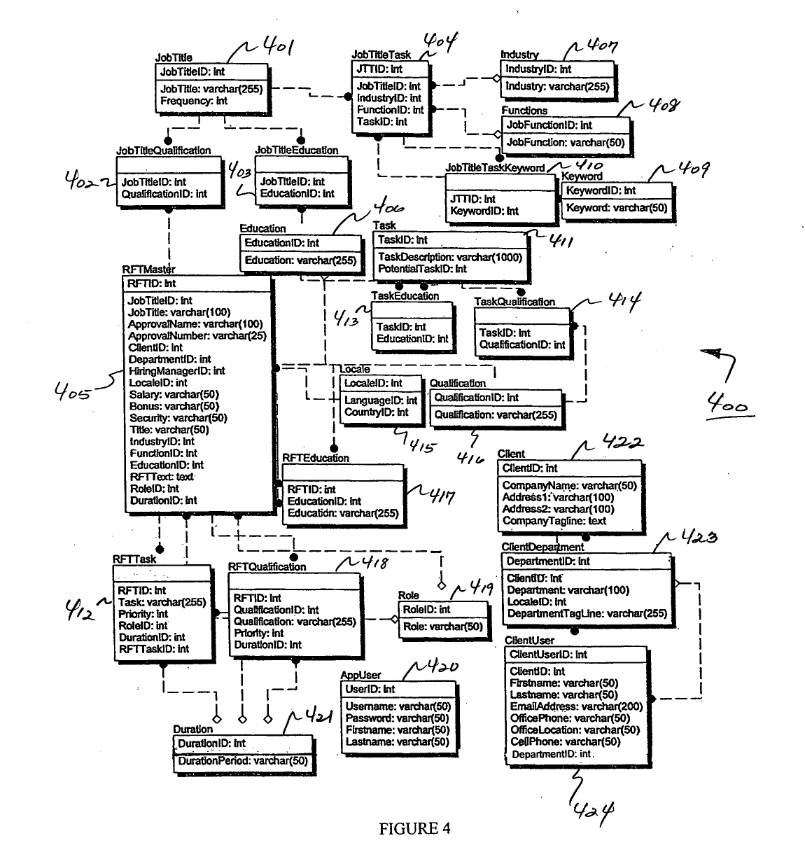

FIG. 4 shows one embodiment of a hierarchical data model for storing RFT-related information. As shown in FIG. 4, job-related information may be expressed and stored as a number of object-oriented objects. In one embodiment, the data model is expressed as an object hierarchy 400 including a plurality of interrelated objects.

Hierarchy 400 includes a JobTitle object 401 which represents a unique job within the data model. The JobTitle object 401 may be uniquely represented using a JobTitleID which may be, for example, an integer that uniquely identifies a particular job. Also associated with the JobTitle object 401 is a JobTitle description which is a real-text description of the particular job associated with the JobTitleID.

Associated with each JobTitle object 401 may be one or more additional objects that describe the particular JobTitle. For instance, there may be other associated objects that relate the qualifications, education, and task to be formed by a person having that job title. As shown in FIG. 4, the JobTitle object 401 includes an associated JobTitleQualification object 402 which represents a particular qualification associated with the JobTitle object 401. Object 402 may include JobTitleID to which the qualification is associated and a qualification ID which uniquely identifies the particular qualification.

JobTitle object 401 may also have a JobTitleEducation object 403 associated with it that identifies for the particular JobTitle, an educational requirement. In one embodiment, JobTitleEducation object 403 includes a JobTitleID with which the particular educational requirement is associated, and an EducationID which uniquely identifies a particular education.

JobTitle object 401 may also include an associated JobTitleTask object 404 which identifies a particular task associated with the particular JobTitle. JobTitleTask object 404 may include a JobTitleTaskID (JTTID) which may identify an association between a particular task and a particular JobTitle. In one embodiment, it is realized that there may be different tasks associated with a particular JobTitle for different industries and job functions. For instance, an administrative assistant in the legal industry may have to perform different tasks than an administrative assistant for an engineering group. Because it may be useful to store different task associations with different industries and job functions, according to one embodiment, the system stores industry and job function information. In one embodiment, the system stores an industry object 407 which includes an Industry ID which uniquely identifies a particular industry, and an industry description which includes a real text description of the particular industry. Hierarchy 400 may also include a Functions object 408 that represents a particular job function. Functions object 408 may include a JobFunctionID that uniquely identifies a particular job function (e.g., JobFunction) within the system. Functions object 408 may include a JobFunction description which is a real text description of the identified JobFunction.

The JobTitleTask object 404 may have one or more associated keywords associated with a particular JobTitleTaskID (JTTID). These one or more keywords may be represented by a keyword object 409 having a keyword ID which uniquely identifies a particular keyword in the database. The keyword may have an associated keyword description that identifies keywords related to a particular job title (e.g., JobTitle). The one or more keywords may be related to a JobTitleTaskKeyword object 410 which includes a JTTID and an associated KeywordID that relates the Keyword to the JobTitleTask. Hierarchy 400 may also include an education object 406 that represents a particular educational requirement. Education object may be associated with a particular JobTitle using the JobTitleEducation object 403.

Hierarchy 400 may also include a task object 411 that represents a task associated with a particular RFT. As discussed above, these tasks may be required tasks to be performed by a candidate in the job associated with the RFT, or may be a preferred task for which a particular candidate may have a qualification. Task object 411 may have an associated TaskID that uniquely identifies a task in the database. Task object 411 may include an associated TaskDescription which is a real text description of the task that will be performed by the candidate if hired. Hierarchy 400 may also include a TaskEducation object 413 that identifies an education that is required to perform a particular task. TaskEducation object 413 may include a TaskID that identifies a particular task and associates that particular task with an EducationID that identifies an educational requirement.

Hierarchy 400 may include TaskQualification object 414 that associates a task with a particular qualification. Such a qualification may be represented, for example, by Qualification object 416 which identifies a qualification for a particular task. As discussed above, the QualificationObject 416 may be related to a particular task using TaskQualificationObject 414. QualificationObject 416 may include a QualificationID that uniquely identifies a qualification in the database. QualificationObject 416 may also include a Qualification description that is a real-text description of the qualification represented by the QualificationID.

Hierarchy 400 may include an RFTMaster object 405 that stores information relating to the current RFT being developed. Object 405 may store a number of different pieces of information related to the current RFT including, but not limited to, the job title and ID for use with the current RFT, client ID, department ID, Hiring Manager ID, and other information. This information, if stored, may be then accessed in the future (e.g., in a future RFT development session, or editing session). For instance, particular elements of the stored RFT (e.g. tasks, qualifications, job titles) may be made available to future sessions. Also, the RFT being developed may be stored as a whole (or as references to individual parts) so that individual RFTs may be queried, edited, printed, etc.

Hierarchy 400 may include an RFTEducation object 417 that represents a link between an RFT and education that may be required for a particular RFT. RFTEducation object 417 includes an RFT ID that uniquely identifies the RFT for which the education may be associated. RFTEducation object 417 may also track the education ID associated with the RFT and a description associated with the EducationID.

Hierarchy 400 may also include an RFT task object 412 that stores task information associated with the current RFT being developed.

Hierarchy 400 may also include an RFTQualification object 418 which is an association between an RFT currently being created and the qualification stored in the database. RFTQualification object 418 may include, for example, an RFTID that identifies the particular RFT associated with the qualification represented by the QualificationID that uniquely identifies a qualification in the database. Further, RFTQualification object 418 may include a Qualification description that is a plain text description of the qualification represented by the QualificationID. In accordance with one embodiment of the invention, the RFTQualification object 418 includes a priority setting that allows a user (e.g., a client or specialist) to adjust the priority of the qualification with respect to other qualifications specified in the RFT. In this manner, a more accurate job description may be developed as a result, as some qualifications may be preferable to others. Similarly, RFT task object 412 may also have a priority setting that allows a user to rank particular tasks with respect to other tasks.

Hierarchy 400 may also include a duration object 421 that represents a duration of experience, either in performing a particular task, or a certain duration of experience of a particular qualification. Duration object 421 allows, for example, a user to specify the period of experience required for a particular task or qualification, and this allows a user (e.g., a specialist or client) to create a more accurate RFT, as more specific information relating to what qualifications and/or task experiences are needed is captured by the system.

Hierarchy 400 may also include a role object 419 which identifies a particular role associated with a qualification. For example, if working on a software development project, there may be one or more roles that could be specified with that particular qualification. For example, one role associated with the software development project could be “senior architect”, and a candidate can have certain duration of experience in that particular role.

Hierarchy 400 may also include information relating to the client such as Client object 422 that stores contact information for the client, client department information stored by ClientDepartment object 23 that stores a department description and LocaleID that identify a particular client within a client company.

Hierarchy 400 may also include a ClientUser object 424 that identifies a particular user within the client organization that can use the recruitment process management system. As discussed above with respect to Client object 422, ClientUser object 422 may include contact information for a particular client user.

Hierarchy 400 may also include an AppUser object 420 which stores information relating to a user of the recruitment process management system. Such information may include, for example, the user name, password, and first and last name of the user.

FIG. 5 shows an example user interface 500 according to one embodiment of the present invention. In one embodiment, this interface may be displayed in a window of a general-purpose computer as discussed above with reference to FIG. 1.

Interface 500 includes a login interface 501 having fields 502, 503 in which a user may enter a user name and password, respectively. When entered, the user may select a sign-in button 504 that invokes a login procedure within the recruitment management system. Interface 500 may be presented to a user such as a client and/or a requirement specialist. As discussed above, a user interface may be developed using the well-known NET framework. In one embodiment, interface 500 is created using Windows forms or the ASP.NET framework (Active Server Pages) available from the Microsoft Corporation. Although various aspects of the invention may be developed using the .NETframework, it should be appreciated that any programming language, framework, or environment may be used, and the invention is not limited to any particular implementation.

FIG. 6 shows another example interface that may be presented by a recruitment process management system. Interface 600 may be presented after a user has authenticated to the system (e.g., at block 302 of FIG. 3). Interface 600 includes a number of sections 601-604 that displays information relating to information currently selected for the current RFT as well as available information stored in the database that may be used to develop the current RFT. As discussed above with reference to FIG. 2, the database may store information relating to previous RFTs, resumes, and other information that may be retrieved and used to develop a new RFT. For instance, section 601 may include information related to stored job titles, industries, and associated functions performed by that particular job title. As discussed above, because a particular job title may have different tasks, qualifications, etc. associated with it for different industries, it may be beneficial to store information separately for each separate industry/job title combination.

Section 601 includes a list of items within each section which a user may select and use for the current RFT. Section 602 includes a list of keywords and tasks related to such keywords that a user may select for use in the current RFT. Section 603 includes a listing of educational requirements and qualifications that may also be selected for the RFT.

Section 604 includes information associated with the RFT record, including, but not limited to job title, hiring manager, department and company information along with controls for managing previously-created RFTs. Section 605 includes a listing of tasks and qualifications that are selected for the current RFT. Interface 600 also includes a number of commands 606 that allows a user to delete qualifications and tasks, clear the current RFT, generate a text based version of the RFT based on the selections made within interface 600, etc. Command 600 may also include commands which allow the user to prioritize tasks and/or qualifications as discussed in more detail below.

FIG. 7 shows an interface 700 exhibiting an example method of creating an RFT. In this example, a user (e.g., a specialists or client) selects a job title to be used for the request for talent. If such a job title is not previously available in a database, a new job title may be created by entering the description in section 709. If the job title is available, however, it is displayed to the user in section 710 of interface 700. A user may select a particular job title by selecting an entry (e.g., entry 701 corresponding to an administrative assistant) by manipulating a pointing device such as a mouse and selecting a particular entry with the pointing device. Similarly, a user may select an industry associated with a particular job title (e.g., entry 702), and may also select a function (e.g., entry 703). In section 11 of interface 700, the user may select a number of keywords and associated tasks for use in the current RFT. In the example shown, a user may select the IT keyword (entry 704).

Interface 700 may also include a section 712 that lists education and qualification information stored in the database. A user may select for example, entries within these lists for use in the current RFT (e.g., a user may select entry 706). Interface 700 may also include a section 713 that shows each of the tasks (item 707) and qualifications (item 708) selected for the current RFT. In summary, interface 700 includes facilities for choosing among information that was previously used in generating previous job descriptions, and also displays information selected for the current job description.

As discussed above, a user may be allowed to prioritize tasks to be formed by a candidate, if hired. These tasks may be further classified as required tasks (e.g., list 801) that must be performed by a particular candidate and desired tasks (e.g., list 802) which may be desired or preferred of a candidate and, if present, may distinguish one candidate over another.

In one embodiment of the invention, an interface 800 may be presented that allows a user to categorize and prioritize tasks. Interface 800 may include a required task list 801 that lists each of the required tasks. List 801 may have associated with it a prioritization control 804 that allows the user to adjust the relative priority of one task to another (e.g., tasks having a higher priority may be listed higher in the list than other less-important tasks). Similarly, interface 800 may include a desired task list 802 and an associated prioritization control that allows a user to adjust the relative priorities of tasks within the desired task list 802. Interface 800 may also have a control 803 that allows a user to quickly transfer tasks between the required task list 801 and desired task list 802.

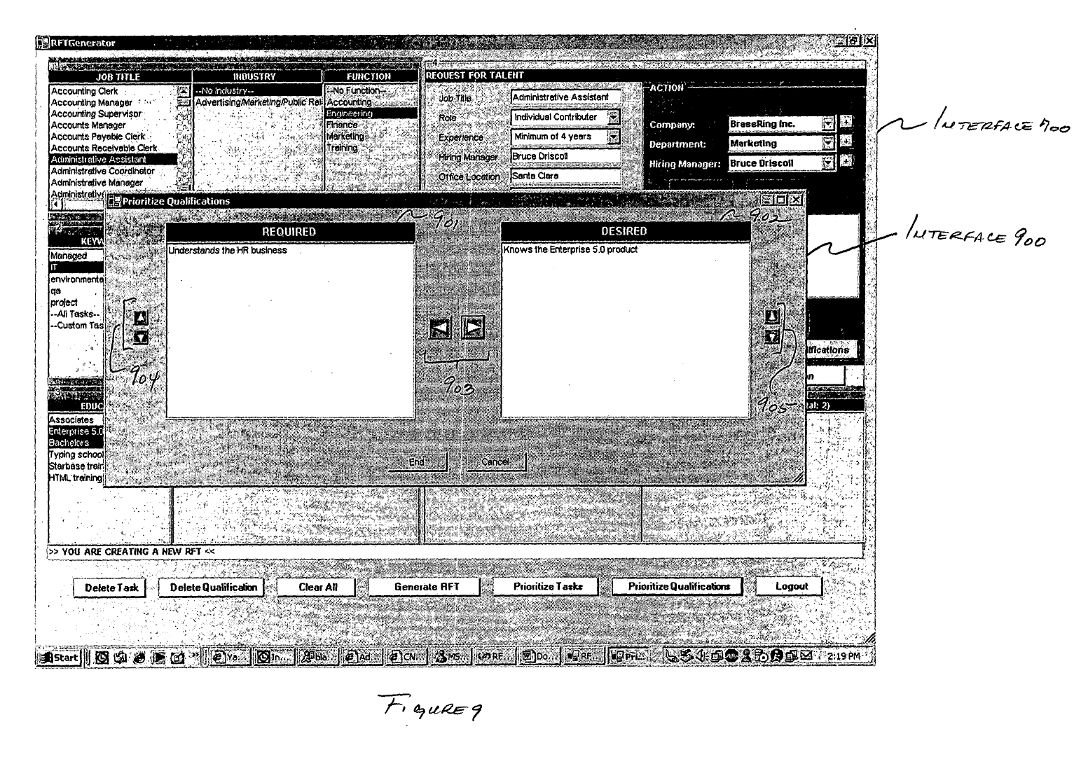

FIG. 9 shows an interface 900 according to one embodiment of the invention that may be presented by a recruitment process management system. Interface 900 may be, for example, initiated when a user selects the “prioritize qualifications” button from interface 700. Interface 900 allows a user to prioritize and classify qualifications. In particular, interface 900 includes a required qualifications list 901 that lists qualifications that a required of a particular candidate. List 901 includes an associated control 904 which allows a user to adjust the priority of a selected qualification higher or lower within list 901, and therefore allows the user to adjust the relative priority of a qualification with respect to other qualifications.

In a similar manner, interface 900 may include a desired qualifications list 902 that lists desired qualifications of a particular candidate. Desired qualifications list 902 includes an associated control 905 that allows a user to adjust the relative priority of a desired qualification with respect to other desired qualifications. Interface 900 also includes a control 903 that allows qualifications to be transferred between the required qualifications list 901 and the desired qualifications list 902.

The system may also include the capability for modifying information stored in a database. In one embodiment, the system presents an interface 1000 that allows a user to modify information associated with a particular task. For instance, interface 1000 may allow user to modify a task description 1001 associated with a particular TaskID. Further, interface 1000 may have controls 1002, 1003 that allow a user to adjust the experience and role, respectively, associated with the task being modified. When the information associated with a task is modified, the information may be saved to the database. Alternatively, changes may be ignored by selecting a control that aborts changes to a database entry (e.g., the cancel button of interface 1000).

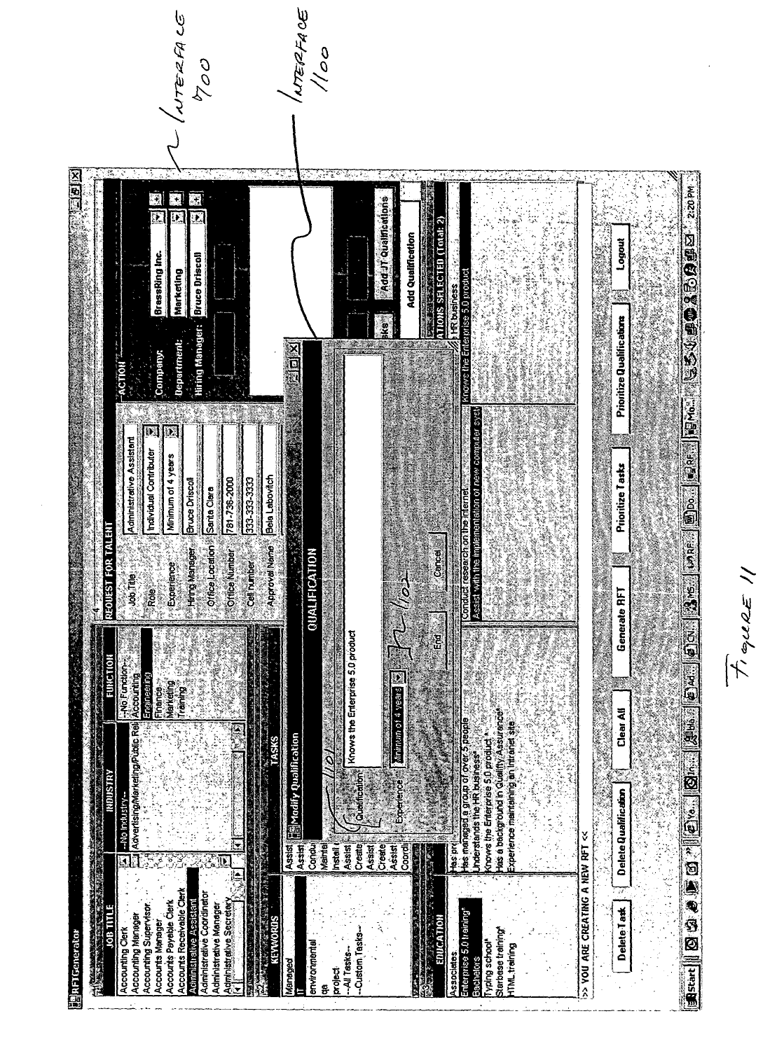

FIG. 11 shows an interface 1100 that allows a user to modify qualifications stored in the database. For instance, interface 1100 may allow a user to modify a description of 1101 associated with a particular QualificationID. Further, interface 1100 may include a control 1102 that allows a user to adjust the experience associated with a particular qualification. When completed, these changes may be committed to the database, or alternatively, saved to the current RFT.

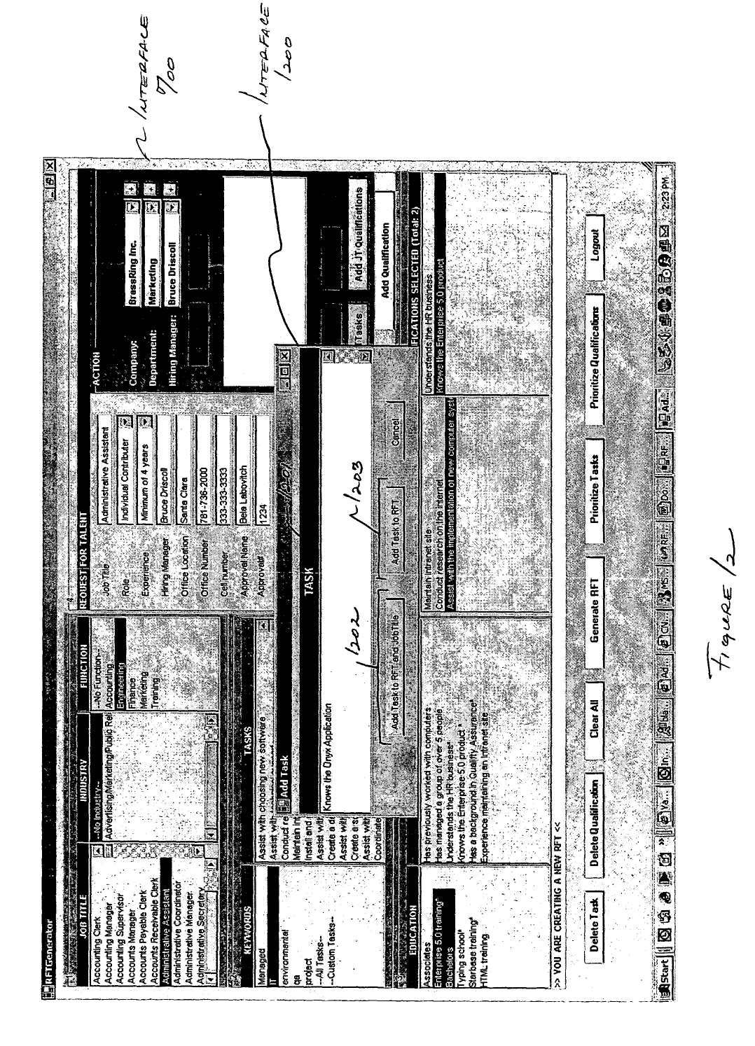

FIG. 12 shows an interface 1200 that may be presented by the system allowing the user to add a task to the current RFT and/or the underline database. For instance, interface 1200 may includes a task description 1201 which is associated with a particular TaskID. Interface 1200 may also include a control 1202 which adds the defined task to the current RFT and also adds it to the selected JobTitle. That is, the current task can be saved to both the current RFT and the underline database. Interface 1200 may also include a control 1203 that only adds the task to the current RFT. That is, it may be necessary to make changes in the current RFT but not necessarily make the same change to the underline database.

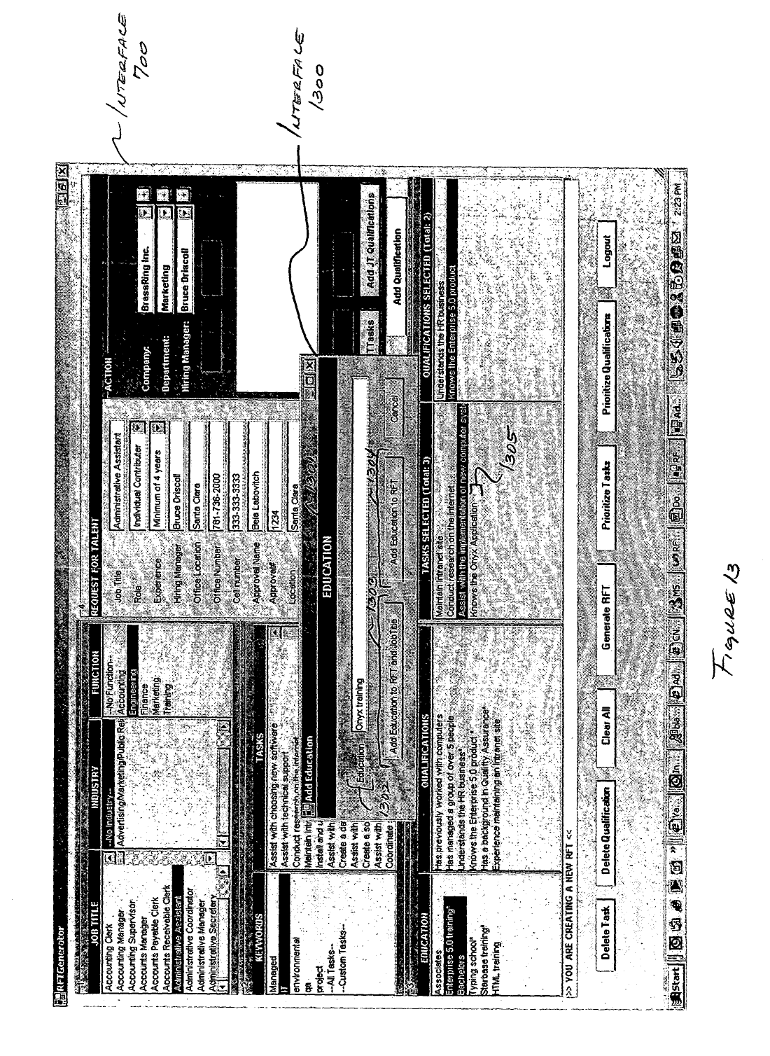

FIG. 13 shows another interface 1300 that may be presented by a recruitment management system that allows the user to add educational information to the current RFT and/or underlying database. In one embodiment, interface 1300 includes a field that allows a user to modify the description 1302 of an educational requirement associated with a particular EducationID. Interface 1300 may also include a control 1303 that adds the education information to the current RFT and the current JobTitle selected (and therefore, the underlying database). Interface 1300 may also include a control 1304 that allows a user to add the education to the current RFT, without committing the changes to the underlying database. As discussed above, it may be preferable to modify information for a particular RFT without changing information stored in the underlying database. Also, as shown in FIG. 13, changes committed to the current RFT may be shown within the interface (e.g., the task added via interface 1200 from FIG. 12 is reflected in the current RFT as item 1305 of interface 700.

As discussed above, it may be preferable to generate a request for talent that can be distributed to potential candidates. This request for talent may be a real-text description of the job that is available, and this request for talent may be generated by a recruitment management process system according to various embodiments of the invention. Such a real-text description of the request for talent may be displayed in an interface 1400 for review by a user. This description 1401 may be generated by the system based on the selections made within interface 700. The recruitment management system may be adapted to insert items selected within interface 700 into preset formats (e.g., lists, preformatted sentences, or any other format) to develop the real text description 1401. Interface 1400 may also include a number of controls 1402 that allows a user to save the currently displayed request for talent 1401, or alternatively, cancel the display of request for talent 1401 and to return to interface 700 without saving RFT 1401. The RFT may be saved, for example, using the underlying database structure shown in FIG. 4 and discussed above, or alternatively, the request for talent may be output in a number of different formats including document formats such as, for example, Microsoft Word format, HTML, or other document format.

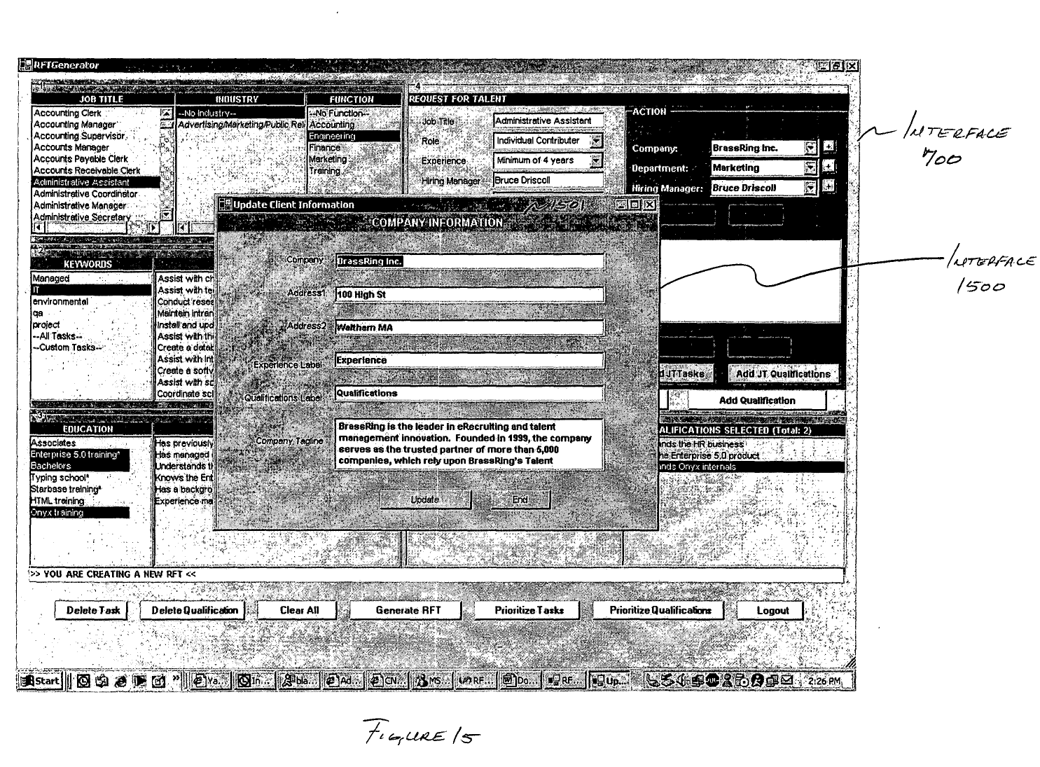

Interface 700 may also provide the capability of modifying company information associated with a particular client. As shown in FIG. 15, an interface 1500 is provided that allows a user to change company information 1501, including, but not limited to company name, address, company brief description (or tagline) or any other preferences (e.g., experience labels, qualification label) that may be used by that particular company in preparing its RFTs.

As discussed above, a recruitment management system according to one embodiment of the invention may allow a user to update information stored in the database. Also as discussed, the database may store information that is related to a particular company and/or department, such that company-specific and/or department-specific information may be saved and used in developing new RFTs. In the example shown, interface 1600 allows a user to update tasks associated with the administrative assistant job title for the company Brass Ring, Inc. In this manner, a user may program a predetermined database associated with a particular company that may be specialized to suit the company's needs.

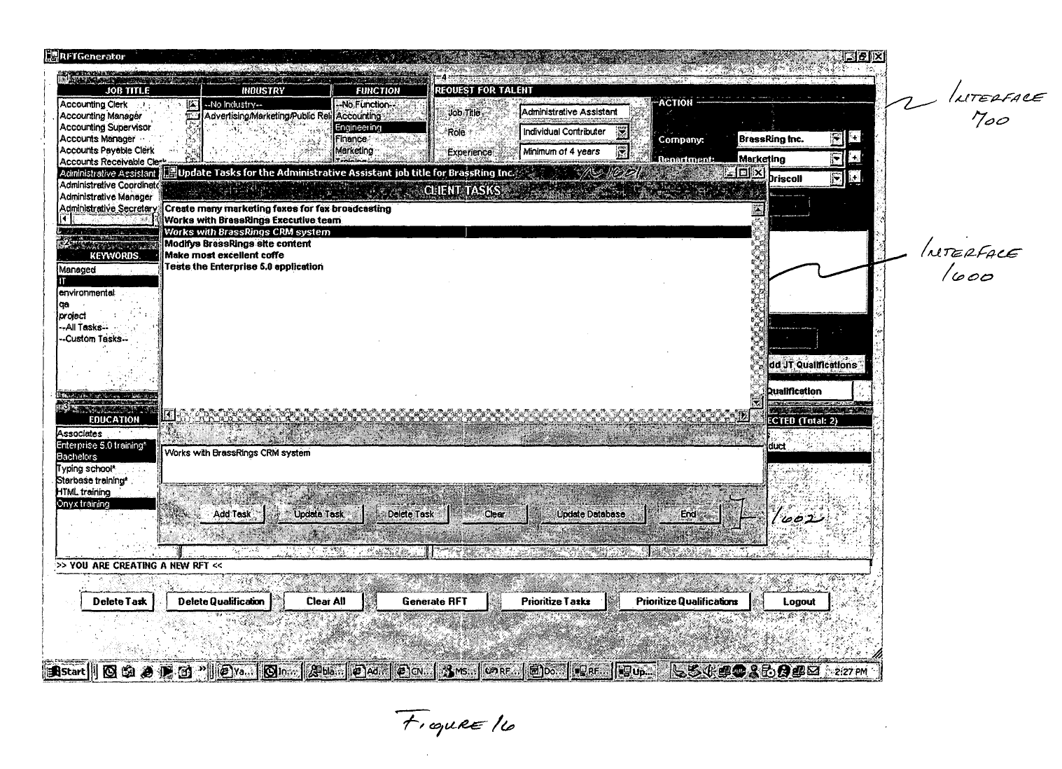

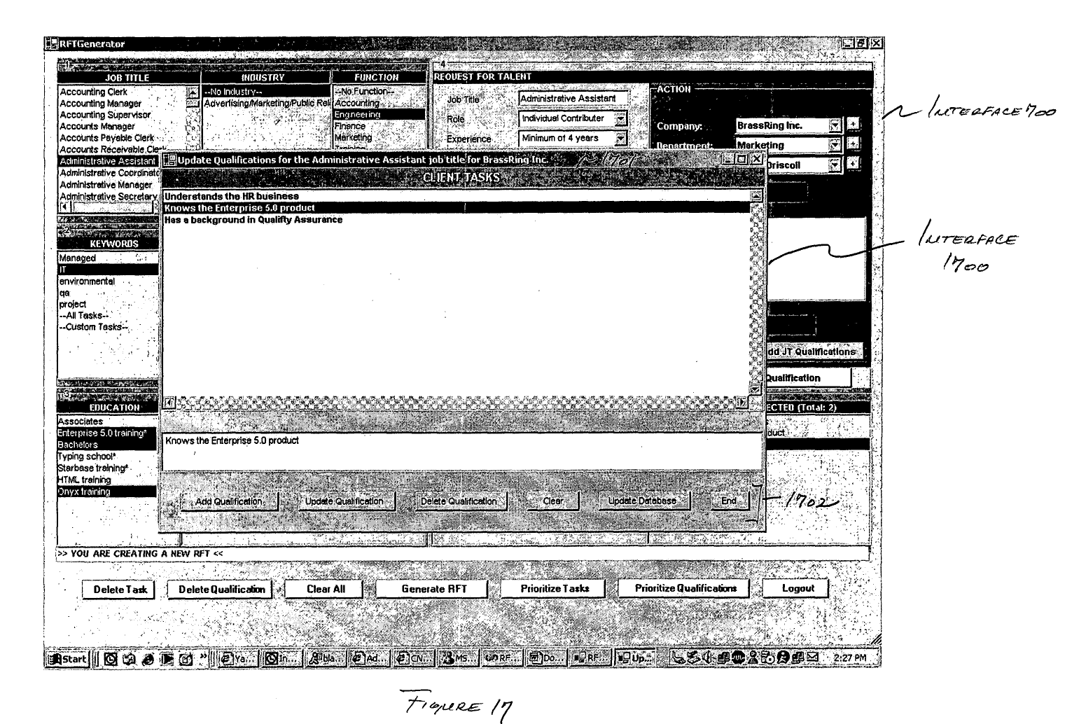

FIG. 17 shows an interface 1700 that allows a user to manage qualifications associated with a particular job title for a particular company. More particularly, interface 1700 may include a number of client tasks as qualifications for, in the example, an administrative assistant job title for Brass Ring, Inc. as discussed above with reference to FIG. 16, the user may be allowed to create their own company-specific list of tasks and qualifications that can be used for development of future RFTs. Interface 1700 may also include a number of controls 1702 to manage qualification entries in the database.

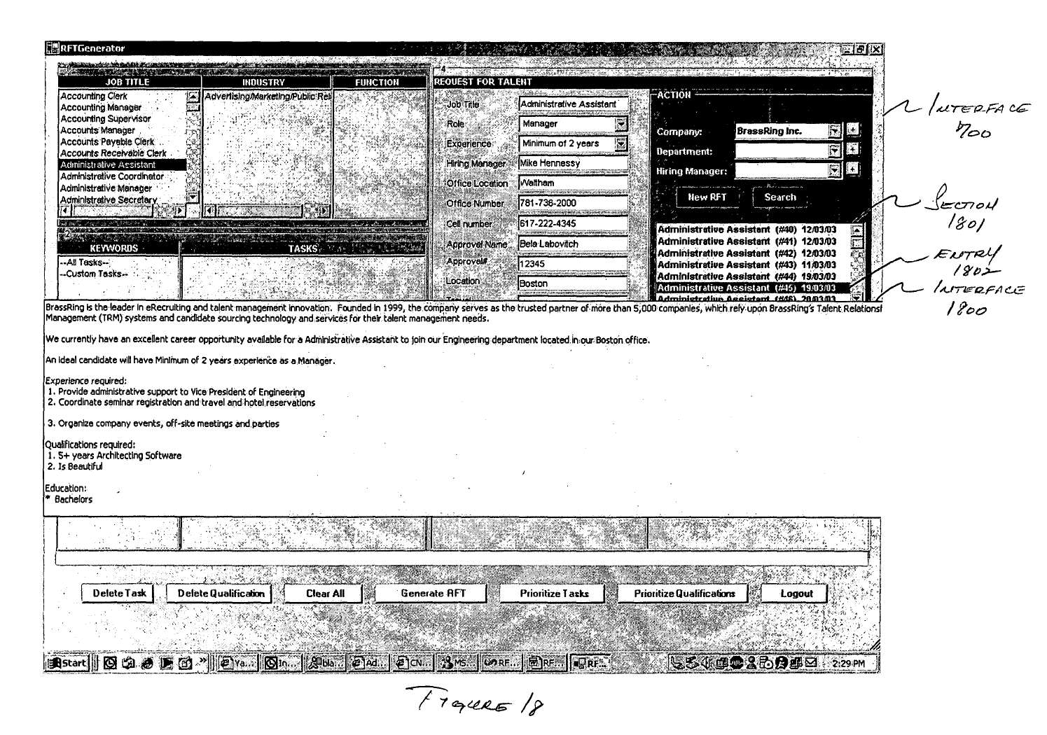

FIG. 18 shows one example interface 1800 that may be presented by a recruitment management system according to one embodiment of the invention. Interface 1800 shows a preview of the currently-selected RFT entry (item 1802) selected within section 1801. This preview capability allows a user to quickly scan the content of previous RFTs generated for a particular company, and these entries may be loaded into the current view to create a new RFT, or to modify information associated with a stored RFT description.

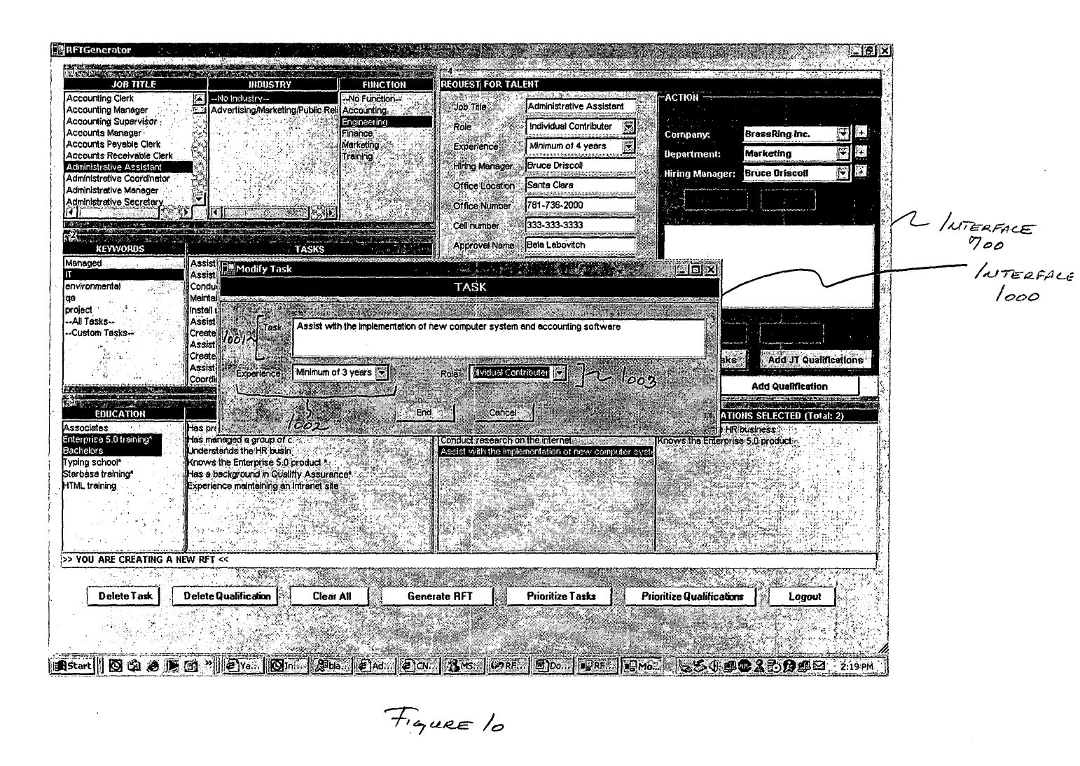

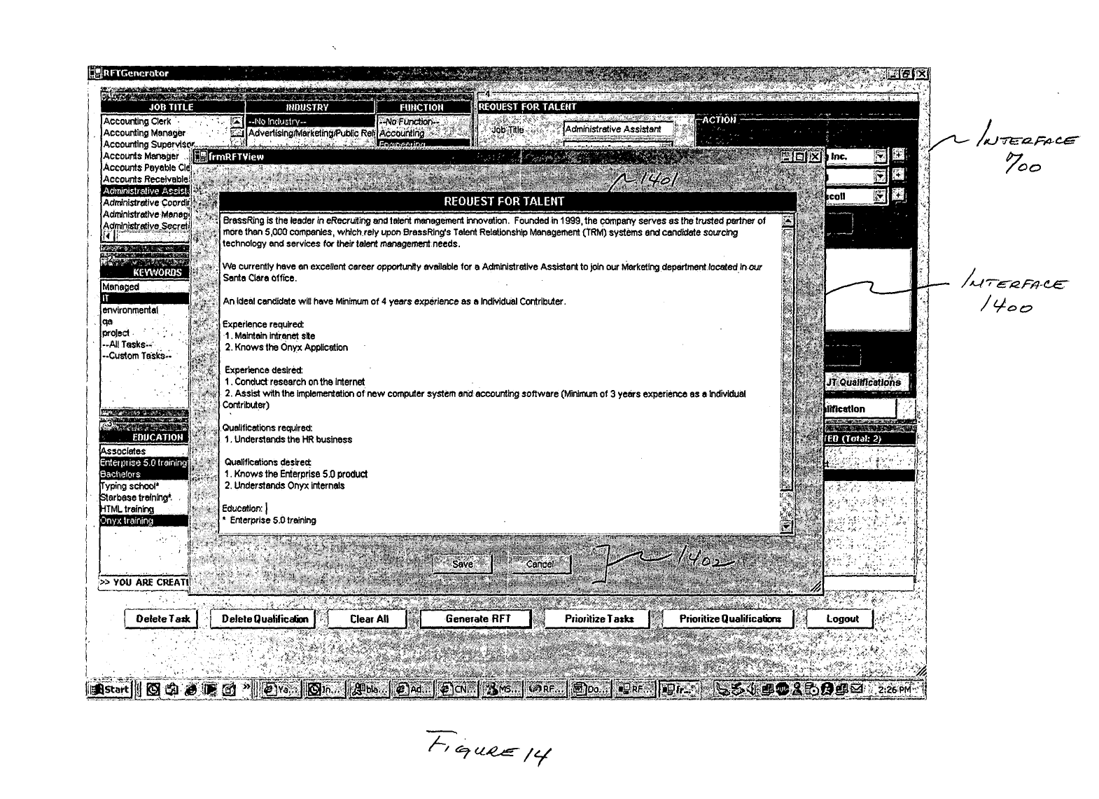

Although various embodiments of user interfaces as described above with reference to FIGS. 5-18, it should be appreciated that these interfaces are merely examples, and that the invention is not limited to the specific examples presented herein. Further, the invention is not limited to any particular combination of features within any interface, and it should be appreciated that various aspects of the invention may be implemented in any interface or interfaces, using any user input or display techniques either known or hereinafter developed.

In addition, this invention is not limited in its application to the details of construction and the arrangement of components set forth in the previous description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A method for managing recruiting information, the method comprising acts of:
developing a job description, the first job description comprising a first set of components;
storing the first set of components in a database; and
creating a second job description having a second set of components, at least one of which is selected from the first set of components stored in the database.

2. The method according to claim 1, further comprising an act of determining, by a requirements specialist, the first set of components.

3. The method according to claim 2, wherein the act of determining comprises an act of receiving, from the requirements specialist, a selection of at least one of the first set of components and simultaneously displaying the selection to a client.

4. The method according to claim 1, wherein the act of storing further comprises an act of storing the first set of components in a relational database.

5. The method according to claim 3, further comprising an act of displaying the selection to the requirements specialist in a display of a computer associated with the requirements specialist.

6. The method according to claim 2, wherein the act of displaying the selection includes an act of displaying the selection to the client in a display of a computer associated with the client.

7. The method according to claim 5, wherein the act of displaying the selection includes an act of displaying the selection to the client in a display of a computer associated with the client.

8. The method according to claim 2, wherein the act of determining comprises an act of determining, by the requirements specialist, the first set of components on the basis of an interactive communication with a client.

9. The method according to claim 1, wherein the acts of developing, storing, and creating are facilitated by the use of at least one computer system.

10. The method according to claim 1, wherein the first set of components comprises at least one component that identifies an educational requirement associated with a candidate.

11. The method according to claim 1, wherein the first set of components comprises at least a task to be performed by a candidate.

12. A method of interactively developing a job description, the method comprising acts of:
receiving, by a requirements specialist from a client, hiring needs; and
determining, by the requirements specialist based on the received hiring needs, at least one portion of a job description.

13. The method according to claim 12, further comprising an act of displaying, in a display of a computer system associated with the client, the at least one portion of the job description determined by the requirements specialist.

14. The method according to claim 13, further comprising an act of displaying, in a display of a computer system associated with the requirements specialist, the at least one portion of the job description determined by the requirements specialist.

15. The method according to claim 12, wherein the at least one portion is stored in a database, and wherein the method further comprises an act of selecting the at least one portion from the database for use in the job description.

16. The method according to claim 15, wherein the at least on portion includes at least one of a group of information comprising:
a task;
a job function;
an educational information; and
a qualification, and wherein the method further comprises selecting the at least one of the group from database for use in the job description.
